(19) United States
(12) Patent Application Publication
(10) Pub. No.: US 2025/0198963 A1
(43) Pub. Date: Jun. 19, 2025

(54) OSCILLATION DEVICE, OSCILLATION SYSTEM, EXTRACTION/IONIZATION SYSTEM, MASS SPECTROMETRY SYSTEM, AND OSCILLATION METHOD

(71) Applicant: OSAKA UNIVERSITY, Osaka (JP)

(72) Inventor: Yoichi OTSUKA, Osaka (JP)

(21) Appl. No.: 18/845,161

(22) PCT Filed: Mar. 13, 2023
(86) PCT No.: PCT/JP2023/009488

§ 371 Date: Sep. 9, 2024

(30) Foreign Application Priority Data
Mar. 11, 2022 (JP) 2022-038565

(51) Int. Cl. G01N 27/62; H01J 49/04; H01J 49/16; H01J 49/26

(52) U.S. Cl. CPC G01N 27/62; H01J 49/0431; H01J 49/165; H01J 49/26

(57) ABSTRACT

This invention provides an oscillation device which stabilizes oscillation of a probe for a long period. An oscillation device (1) that oscillates a probe which is cantilevered and that includes: a probe (2); two fixing members (3, 4) between which the probe (2) is sandwiched and supported; and an oscillation generating part (5) which gives oscillation to at least one of the two fixing members (3, 4), at least one of the two fixing members (3, 4) having a recessed part (10) in which the probe (2) is disposed with the probe (2) being sandwiched between the two fixing members (3, 4), the recessed part (10) being formed in a portion of the at least one of the two fixing members (3, 4) which portion corresponds to the probe (2) in position.

### TECHNICAL FIELD

The present invention relates to an oscillation device, an oscillation system, an extraction-ionization system for a substance, and the like.

### BACKGROUND ART

In the field of an analytical technique, a method that ionizes a plurality of components contained in an analysis target and measures relations between mass-to-charge ratios thereof and quantities thereof is called “mass spectrometry”. As a method for visualizing a distribution of components in an object, such as a biological tissue, containing a plurality of components, there is a mass spectrometry imaging method. As one method for ionizing components contained in a micro area of an object, a method is employed that carries out extraction and ionization with use of a minute amount of solvent.

Patent Literature 1 discloses, as a method for feeding a solvent to an object and a method for ionizing an extraction liquid, a method that carries out both extraction and ionization alternately with use of a single capillary probe. This method carries out, with use of a capillary probe capable of flowing a solvent therein, extraction and ionization with oscillation thereof in an up-down direction. This makes it possible to carry out extraction and ionization at a higher rate, as compared to other methods.

Non-Patent Literature 1 states that employment of a feedback control technique for maintaining a constant oscillation amplitude of a probe can stabilize probe scanning over a rough sample, thereby making it possible to carry out extraction and ionization with fine reproducibility.

### CITATION LIST

### Patent Literature

### Patent Literature 1

Specification of Japanese Patent No. 5955032

### Non-Patent Literature

### Non-patent Literature 1

Yoichi Otsuka et al., “High-Spatial-Resolution Multimodal Imaging by Tapping-Mode Scanning Probe Electrospray Ionization with Feedback Control” Analytical Chemistry, 93, 2263-2272 (2021).

### Non-patent Literature 2

Journal of Chromatography A, 979 (2002) 233-239

### SUMMARY OF INVENTION

### Technical Problem

However, according to the above-described conventional techniques, in order to carry out analysis which requires long-period measurement, it is necessary to stabilize the oscillation of the probe for a long period. A technique for stabilizing the oscillation of the probe for a long period can be utilized not only for ionization for mass spectrometry but also in various technical fields involving use of an oscillating probe.

An aspect of the present invention is to provide an oscillation device and the like each of which stabilizes oscillation of a probe for a long period.

### Solution to Problem

In order to attain the above object, an oscillation device in accordance with an aspect of the present invention is an oscillation device that oscillates a probe which is cantilevered, the oscillation device including: a probe; two fixing members between which the probe is sandwiched and supported; and a oscillation generating part which gives oscillation to at least one of the two fixing members, at least one of the two fixing members having a recessed part in which the probe is disposed with the probe being sandwiched between the two fixing members, the recessed part being formed in a portion of the at least one of the two fixing members which portion corresponds to the probe in position.

An oscillation method in accordance with an aspect of the present invention is an oscillation method that oscillates a probe which is cantilevered, the oscillation method including the steps of: sandwiching and supporting the probe between two fixing members so that the probe is disposed in a recessed part of at least one of the two fixing members with the probe being sandwiched between the two fixing members, the recessed part being formed in a portion of the at least one of the two fixing members which portion corresponds to the probe in position; and giving oscillation to one of the two fixing members.

### Advantageous Effects of Invention

In accordance with an aspect of the present invention, it is possible to provide an oscillation device and the like each of which stabilizes oscillation of a probe for a long period.

### BRIEF DESCRIPTION OF DRAWINGS

FIG. 1 is a view illustrating a configuration of an oscillation device in accordance with an embodiment of the present invention.

FIG. 2 is a view schematically illustrating a cross section taken along line A-A in FIG. 1.

FIG. 3 is an exploded perspective view illustrating a configuration of the oscillation device in accordance with the embodiment of the present invention.

FIG. 4 is a view illustrating a variation of the oscillation device in accordance with the embodiment of the present invention.

FIG. 5 is a view illustrating a variation of the oscillation device in accordance with the embodiment of the present invention.

FIG. 6 is a view illustrating a configuration of an extraction-ionization system and a mass spectrometry system in accordance with an embodiment of the present invention.

FIG. 7 is a view illustrating a result of measurement of an oscillation amplitude of a probe of an oscillation device in accordance with an example of the present embodiment, the measurement having been carried out with use of an oscillation measurement part.

FIG. 8 is a view illustrating a result of measurement of an oscillation amplitude of a probe of an oscillation device for comparison, the measurement having been carried out by a video camera.

FIG. 9 is a view illustrating results of visualization of component distributions in slices of mouse brain tissues, the visualization having been carried out by a mass spectrometer.

FIG. 10 is a view illustrating a configuration of an extraction-ionization system and a mass spectrometry system including an oscillation system in accordance with an embodiment of the present invention.

FIG. 11 is a view of the mass spectrometry system and the extraction-ionization system shown in FIG. 10, viewed in a direction of the arrow Y in FIG. 10.

FIG. 12 shows results of optical microscopic observation of a probe and particles filled in the probe.

FIG. 13 shows results of observation of cases where a probe filled with particles A was used and −4 kV voltage was applied to a solvent.

FIG. 14 shows results of observation of cases where a probe filled with particles A was used and +4 kV voltage was applied to a solvent.

FIG. 15 shows results of observation of cases where a probe filled with particles B was used and −4 kV voltage was applied to a solvent.

FIG. 16 shows results of observation of cases where a probe filled with particles B was used and +4 kV voltage was applied to a solvent.

FIG. 17 shows results of measurement of a component distribution in cells, the measurement having been carried out with use of a probe filled with particles.

FIG. 18 shows results of optical microscopic observation of a tip-end area of a probe having been used for measurement.

### DESCRIPTION OF EMBODIMENTS

### First Embodiment

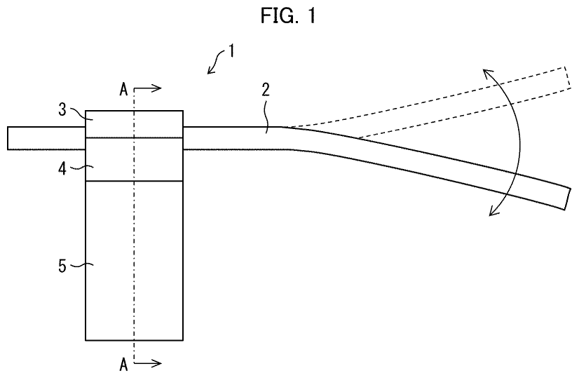

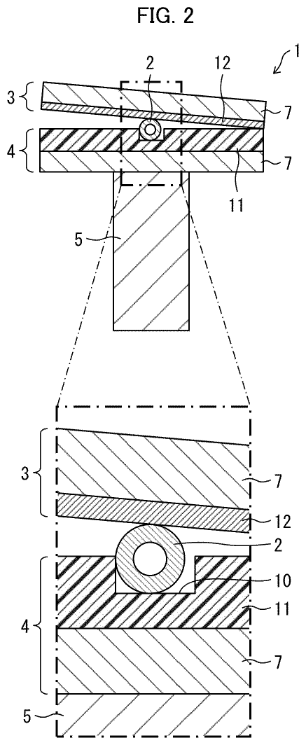

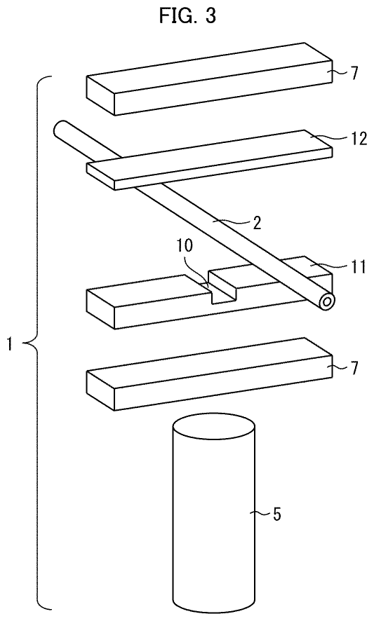

The following description will provide details of an embodiment of the present invention. FIG. 1 is a view illustrating a configuration of an oscillation device 1 in accordance with an embodiment of the present invention. FIG. 2 is a view schematically illustrating a cross section taken along line A-A in FIG. 1. FIG. 3 is an exploded perspective view illustrating a configuration of the oscillation device 1 in accordance with the embodiment of the present invention.

As shown in FIG. 1, the oscillation device 1 is an oscillation device that oscillates a probe 2 which is cantilevered. As shown in FIG. 1, the oscillation device 1 includes the probe 2, two fixing members 3 and 4 between which the probe 2 is sandwiched and supported, and an oscillation generating part 5 which gives oscillation to at least one of the two fixing members 3 and 4. In the oscillation device 1, at least one of the two fixing members 3 and 4 has a recessed part 10 in which the probe 2 is disposed with the probe 2 being sandwiched between the two fixing members 3 and 4, the recessed part 10 being formed in a portion of the at least one of the two fixing members 3 and 4 which portion corresponds to the probe 2 in 10 position. In the example shown in FIG. 1, the recessed part 10 is formed in the fixing member 4. Alternatively, the recessed part 10 may be provided in the fixing member 3. Further alternatively, recessed parts 10 may be formed in both the two fixing members 3 and 4.

The probe 2 is a minute needle which is 10 μm to 1 mm in diameter and 1 mm to 1000 mm in length. The probe 2 may be a tubular member having a flow passage which is provided in an inside of the tubular member and through which a liquid passes. Alternatively, the probe 2 may be solid inside. The probe 2 is made of a soft material which would not have permanent mechanical deformation but cause displacement of one end of the probe 2 in response to oscillation of the probe 2. Examples of such a material include glass, metal, resin, and composite materials thereof. However, there is no particular limitation on the material.

The two fixing members 3 and 4 may be any members, provided that they have inner surfaces which face each other (surfaces facing the probe) and between which the probe 2 can be sandwiched and supported. In each of the examples shown in FIGS. 2 and 3, each of the two fixing members 3 and 4 is a rectangular plate-shaped member. However, this is not limitative. The two fixing members 3 and 4 only need to have inner surfaces which face each other and between which the probe 2 is sandwiched and supported.

A direction in which the probe 2 is sandwiched between the two fixing members 3 and 4 preferably coincides with an oscillation direction (e.g., an up-down direction) of the probe 2. This makes it possible to fix the probe 2 securely, thereby effectively preventing or suppressing shifting of the position of a fixed end in the course of a process.

The oscillation generating part 5 may be any element, provided that it can generate oscillation. For example, the oscillation generating part 5 can be a piezoelectric element (piezoelectric actuator) or an oscillation motor.

In each of the examples shown in FIGS. 1 and 2, the oscillation generating part 5 is located below the fixing member 4, is connected to the fixing member 4, and is configured to apply oscillation to the fixing member 4. Alternatively, the oscillation generating part 5 may be located above the fixing member 3, may be connected to the fixing member 3, and may be configured to apply oscillation to the fixing member 3. The oscillation generating part 5 may or may not be fixed to the fixing member 3 or 4 via an adhesive or the like. That is to say, it is only necessary that the oscillation generating part 5 be configured to transmit oscillation to the fixing member 3 or 4.

With such a configuration, the probe 2 is disposed in (enters) the recessed part 10 with the probe 2 being sandwiched between the two fixing members 3 and 4. This restricts movement of the probe 2 in a lateral direction orthogonal to an axial direction of the probe 2. This can prevent or suppress so-called sideslip of the probe 2. Consequently, it is possible to hold the probe 2 in a more stable manner, as compared to a configuration in which no recessed part 10 is formed. As a result, it is possible to stabilize oscillation of the probe for a long period.

Furthermore, the probe 2 is merely sandwiched between the two fixing members 3 and 4. Thus, it is possible to detach the probe 2 from the oscillation device 1 by cancelling the sandwiching. This makes the probe 2 replaceable with another one. Moreover, by changing the position where the probe 2 is sandwiched (i.e., the position in the axial direction), it is possible to easily change a resonance frequency at which the probe 2 is oscillated, for example.

Both the two fixing members 3 and 4 may have permanent magnets. Alternatively, one of the two fixing members 3 and 4 has a permanent magnet and the other of the two fixing members 3 and 4 has a magnetic substance. In each of the examples shown in FIGS. 2 and 3, both the two fixing members 3 and 4 respectively have magnet parts 7, each of which is a permanent magnet. The magnetic substance is preferably a ferromagnetic substance having strong force for fixing the probe 2. Alternatively, the magnetic substance may be another paramagnetic substance capable of fixing the probe 2.

With such a configuration, the two fixing members 3 and 4 attract each other by magnetic force, so as to be fixed. Thus, it is not necessary to provide an additional fixing mechanism for fixing the two fixing members 3 and 4, between which the probe 2 is sandwiched, to each other.

The recessed part 10 may be formed in at least one of the two fixing members 3 and 4 when the probe 2 is sandwiched between the two fixing members 3 and 4. For this, at least one of inner surfaces (surfaces facing the probe 2) of the two fixing members 3 and 4 is made of an elastic material. This allows the probe 2 to cause elastic deformation of at least one of the two fixing members 3 and 4, thereby forming the recessed part 10.

Further, the recessed part 10 may be formed in at least one of the two fixing members 3 and 4 in advance. The expression “the recessed part 10 is formed in advance” means that the recessed part 10 is present also in a state where the probe 2 is not sandwiched. That is, this expression means a state in which a groove is formed. With such a configuration, each of the two fixing members 3 and 4 can be made of a material which is not elastically deformed when the probe 2 is sandwiched. This can prevent or suppress absorption of oscillation of the two fixing members 3 and 4.

In a case where the recessed part 10 is formed in advance, the recessed part 10 is designed to have a depth (in a case where the recessed parts 10 are provided to both the two fixing members 3 and 4, a total depth thereof) which is not more than a diameter of the probe 2. With this, no space allowing free movement in the oscillation direction of the probe 2 is formed, which makes it possible to fix the probe 2 securely. The recessed part 10 which is formed in advance may have a shape having a rectangular cross section as illustrated in FIGS. 2 and 3, or may alternatively have a shape having a V-shaped cross section, a shape having a semicircular cross section, or the like.

Further, as illustrated in the examples shown in FIGS. 2 and 3, at least one of the two fixing members 3 and 4 may have a resin part 11 in an inner surface of the at least one of the two fixing members 3 and 4, and the recessed part 10 may be formed in the resin part 11. In the examples shown in FIGS. 2 and 3, the fixing member 4 has the resin part 11.

With such a configuration, it is possible to form the recessed part 10 by making use of elasticity of the resin part 11. In a case where the recessed part 10 is formed in advance, it is easy to process the resin part 11 to form the recessed part 10 in the resin part 11.

Such a resin part 11 may be detachably attached to the fixing member 3 or 4 provided with the resin part 11. This configuration makes the resin part 11 replaceable with another one. Further, in the case where the recessed part 10 is formed in the resin part 11 in advance, it is possible to deal with probes 2 of different sizes by selecting recessed parts 10 corresponding to outer diameter sizes of the probes 2.

Note that the resin part 11 is not essential. Alternatively, the recessed part 10 may be directly formed in the fixing member 3 or 4. For example, as shown in FIG. 2, in the configuration in which the fixing members 3 and 4 respectively have the magnet parts 7, the recessed part 10 may be formed to inner surfaces of the magnet parts 7. In the configuration in which one of the fixing members 3 and 4 includes a magnetic substance instead of the magnet part 7, the recessed part 10 may be formed to an inner surface of the magnetic substance.

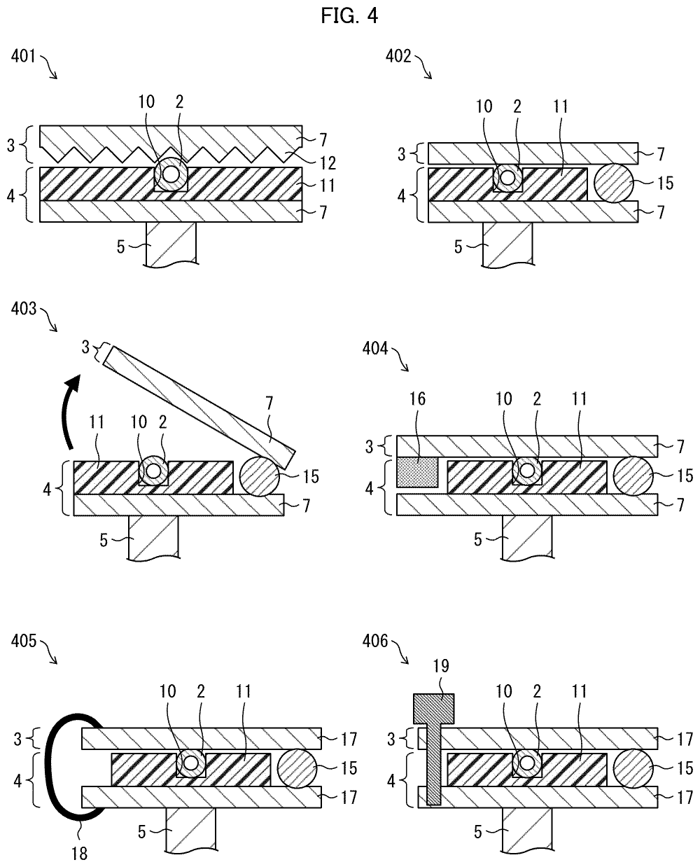

As shown in the later-described drawings with reference signs 405 and 406 in FIG. 4, in a configuration in which the two fixing members 3 and 4 respectively have two plate members 17 instead of the magnet part(s) 7 or the magnetic substance(s), the recessed part 10 may be formed to inner surfaces of the two plate members 17.

Further, one of the two fixing members 3 and 4 may have the recessed part 10 formed therein, and the other of the two fixing members 3 and 4 which does not have the recessed part 10 may have a friction part in an inner surface (a surface facing the probe 2) of the other of the two fixing members 3 and 4, the friction part being configured to be in contact with the probe 2 to restrict movement of the probe 2 by friction force. In the examples shown in FIGS. 2 and 3, a friction part 12 is provided to an inner surface (an inner surface of the magnet part 7) of the fixing member 3, which does not have the recessed part 10. Provision of the friction part 12 restricts movement of the probe 2, thereby making it possible to hold the probe 2 in a more stable manner.

The friction part 12 can be formed by, e.g., adhering a commercially-available anti-slip tape (friction tape) to the inner surface of the fixing member 3. Alternatively, as shown in the drawing with reference sign 401 in FIG. 4, a friction part 12 may be formed by creating roughness on an inner surface of a fixing member 3. In this case, the friction part 12 is made of a substance of which a magnet part 7 or a magnetic substance constituting the fixing member 3 is made. Alternatively, a friction part 12 may be formed by applying, to an inner surface of a fixing member 3, an ink containing micro-scale particles (this configuration is not illustrated).

Further, one of the two fixing members 3 and 4 may have the recessed part 10 formed in advance, the recessed part 10 may have a shape having a rectangular cross section, and the other of the two fixing members 3 and 4 which does not have the recessed part 10 may be in contact with the probe 2 disposed in the recessed part 10. In the example shown in FIG. 2, the probe 2 disposed in the recessed part 10 is pressed by the fixing member 3, which does not have the recessed part 10, so that the probe 2 is in contact with one wall of the recessed part 10, which has a shape having a rectangular cross section.

With this, in the configuration in which the recessed part 10 is formed in advance, it is possible to support the probe 2 in a stable manner. That is to say, in the case where the recessed part 10 is formed in advance, the recessed part 10 is formed to have a larger size than the outer diameter of the probe 2 so as to adapt a variation in outer diameter of the probe 2, and thus the recessed part 10 has a space allowing free movement. Even in such a case, by pressing the probe 2 to bring the probe 2 into partial contact with an opposite wall (in the example in FIG. 2, a left-side wall) of the recessed part 10 in the above-described manner, it is possible to support the probe 2 in a stable manner.

### Variations

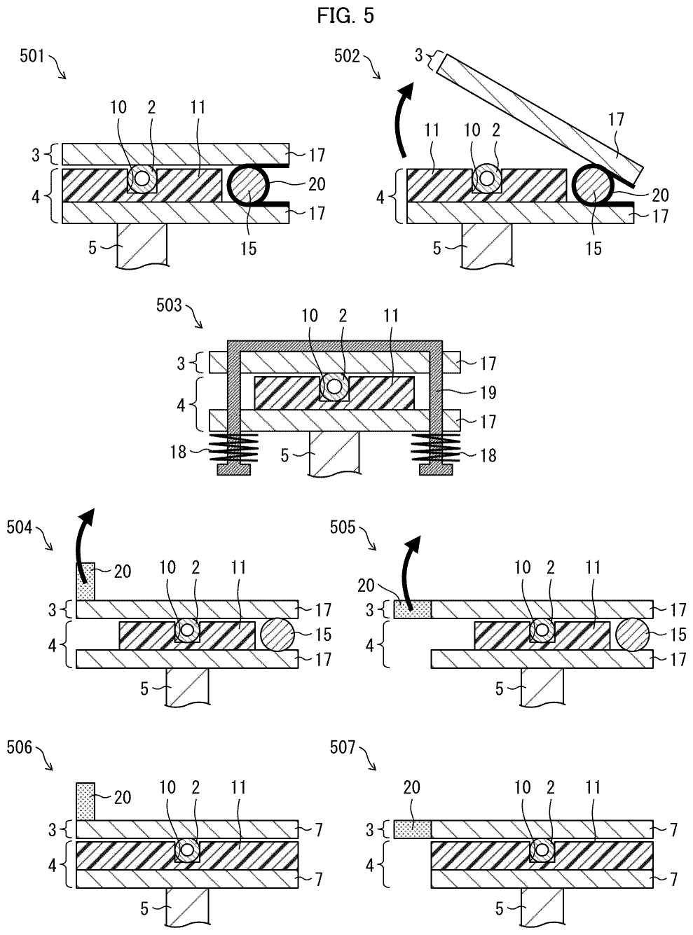

The following description will discuss, with reference to FIGS. 4 and 5, variations of the oscillation device. FIGS. 4 and 5 are views illustrating variations of the oscillation device. Note that, for convenience, members having identical functions to those of the foregoing embodiment are given identical reference signs, and their descriptions will be omitted.
(1) Oscillation devices illustrated with reference signs 402 and 403 in FIG. 4 each include a hinge 15 via which two fixing members 3 and 4 are connected to each other. With this, the two fixing members 3 and 4 would not be separated from each other. This facilitates management. Furthermore, this enhances reproducibility of relative positions of the fixing members 3 and 4.
(2) An oscillation device illustrated with reference sign 404 in FIG. 4 is configured such that two fixing members 3 and 4 attract each other by magnetic force so as to be fixed, and includes a protruding part 16 which reduces a distance between the two fixing members 3 and 4. The protruding part 16 is a magnet or a magnetic substance. In the oscillation device illustrated with reference sign 404, the protruding part 16 is formed on an inner surface of the fixing member 3. Alternatively, the protruding part 16 may be formed on an inner surface of the fixing member 4. Further alternatively, protruding parts 16 may be formed on both inner surfaces of the two fixing members 3 and 4.

In a configuration in which at least one of the fixing members 3 and 4 has a resin part 11, a distance between magnet parts 7 (or magnetic substances) increases for a thickness of the resin part 11. In order to deal with this, this configuration can be employed to strengthen the magnetic force, thereby fixing the two fixing members 3 and 4 securely.
(3) Oscillation devices illustrated with reference signs 405 and 406 in FIG. 4 are each configured such that two fixing members 3 and 4 are fixed by force other than magnetic force. In each of the oscillation devices illustrated with reference signs 405 and 406, the fixing members 3 and 4 include, instead of the magnet parts 7 (or the magnetic substances), two plate members 17 arranged so as to face each other.

In the oscillation device illustrated with reference sign 405, the two fixing members 3 and 4 respectively having the plate members 17 are fixed by being subjected to force, applied by a spring 18 (plate spring), which causes the fixing members 3 and 4 to get closer to each other. In the oscillation device illustrated with reference sign 406, the two fixing members 3 and 4 are fixed with use of a fastening member 19 (here, e.g., a screw).

As each of the oscillation devices illustrated with reference signs 404 to 406 in FIG. 4, a configuration including include the hinge 15 and the resin part 11 is illustrated as an example. Alternatively, each of these oscillation devices may not include the hinge 15 or the resin part 11.
(4) Oscillation devices illustrated with reference signs 501 and 502 in FIG. 5 each include a helical torsion spring 20 incorporated into a hinge 15 via which two fixing members 3 and 4 are connected to each other. The two fixing members 3 and 4 respectively having the plate members 17 are fixed by force, given by the helical torsion spring 20, which causes the fixing members 3 and 4 to get close to each other. Similarly to a clip, by applying force to ends of the two fixing members 3 and 4, the two fixing members 3 and 4 can be separated away from each other against the force given by the helical torsion spring 20.
(5) An oscillation device illustrated with reference sign 503 in FIG. 5 includes two or more springs 18 and a fastening member 19 (here, a metal wire) via which two fixing members 3 and 4 respectively having plate members 17 are connected to each other. The fastening member 19 penetrates through the plate members 17 of the two fixing members 3 and 4, and both ends of the fastening member 19 are fixed with the springs 18 on a lower side of the fixing member 4. Here, the springs 18 are compression springs, and push both the ends of the fastening member 19 downward (in a direction away from the fixing member 4). With this, the fixing member 3 is brought into contact with the probe 2 by pressure, so that the fixing member 3 is fixed.
(6) Oscillation devices illustrated with reference signs 504 to 507 in FIG. 5 each include a projection 20 provided in one of two fixing members 3 and 4 (in these drawings, the fixing member 3, which is not fixed to an oscillation generating part 5), the projection 20 being used to pinch the fixing member 3 with the projection 20. Thanks to the projection 20 which can be pinched, it is possible to easily separate the two fixing members 3 and 4 away from each other. Such a configuration is not limited to a certain fixing method between two fixing members, but is applicable to all fixing methods.

### Second Embodiment

The following description will discuss another embodiment of the present invention. Note that, for convenience, members having identical functions to those of the foregoing embodiment are given identical reference signs, and their descriptions will be omitted.

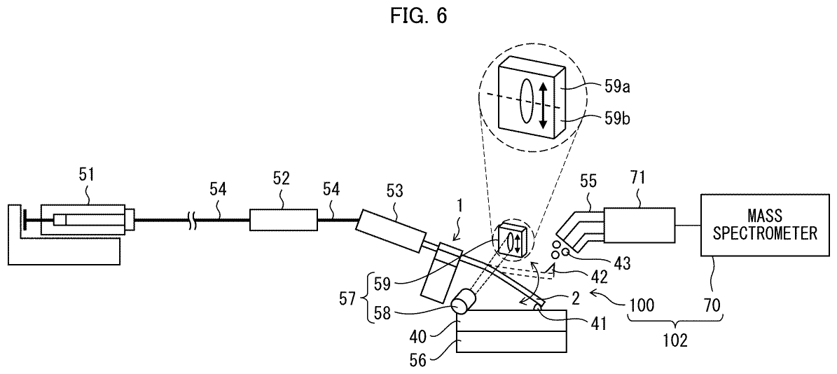

FIG. 6 is a view illustrating a configuration of an extraction-ionization system 100 and a mass spectrometry system 102 in accordance with an embodiment of the present invention. As shown in FIG. 6, the extraction-ionization system 100 includes an oscillation device 1, a liquid feeding device 51, an electrode part 52, a filter part 53, an ion take-in part 55, a stage device 56, and an oscillation measurement part 57. The liquid feeding device 51 and the electrode part 52 are connected to each other via a tube 54, and the electrode part 52 and the filter part 53 are connected to each other via the tube 54. The mass spectrometry system 102 includes the extraction-ionization system 100 and a mass spectrometer 70.

The oscillation device 1 in the extraction-ionization system 100 has a probe 2 having, in its inside, a flow passage through which a liquid flows. The liquid feeding device 51 is configured to feed a solvent (liquid) to the probe 2. Examples of the liquid feeding device 51 include a syringe pump and a pump for liquid chromatography. The electrode part 52 is connected to a voltage application device (not illustrated), and is configured to charge the solvent. The filter part 53 removes a foreign substance contained in the solvent. The ion take-in part 55 is made of metal, and functions as an ion extracting electrode to which a voltage application device (not illustrated) is connected. The ion take-in part 55 takes in an ionized substance, and feeds the ionized substance to the mass spectrometer 70 located downstream of the ion take-in part 55. The ion take-in part 55 has a heater 71 attached thereto, and thus can be heated by the heater 71. On the stage device 56, a sample 40 is placed.

The oscillation measurement part 57 outputs a signal for feedback control for controlling a magnitude of an amplitude of the probe 2. The oscillation measurement part 57 includes a light emitting part 58 and a light receiving part 59. The light emitting part 58 emits a laser beam in a lateral direction orthogonal to an oscillation direction of the probe 2, and then the light receiving part 59 receives the laser beam with a shadow of the probe 2 which is oscillating.

The light receiving part 59 receives transmitted light which is emitted from the light emitting part 58 toward the probe 2 and which is not shielded by the probe 2. The light receiving part 59 outputs a signal indicative of a change in intensity of the received light (i.e., a signal for feedback control, the signal changing along with oscillation of the probe).

An emission range of a laser beam from the light emitting part 58 is set so as to be larger than a diameter of the probe 2. A part of the laser beam from the light emitting part 58 includes a shadow of the probe 2. Along with oscillation of the probe 2, a position of the shadow is displaced in an up-down direction. By detecting changes in intensity of the light received by the light receiving part 59, it is possible to detect movement of the shadow of the probe 2. Thus, it is possible to detect a magnitude of the oscillation of the probe 2 in an indirect manner.

Specifically, as shown in an enlarged view in FIG. 6, the light receiving part 59 is made of a split photodiode, and includes at least two independent light receiving parts 59a and 59b. The light receiving parts 59a and 59b are arranged in a displacement direction (in the enlarged view, the up-down direction indicated by the bidirectional arrow) of the shadow of the probe 2. By measuring a difference between output signals from the light receiving parts 59a and 59b, an oscillation signal is obtained. The oscillation signal is input into a lock-in amplifier (not illustrated), and an amplitude value and a phase value are measured. A signal of the amplitude value is input into a feedback control part (not illustrated), and signal processing for feedback control is carried out.

The feedback control part includes a computing device (which can be a personal computer, a real-time operating system (RTOS), or a field programmable gate array (FPGA)), an analog-to-digital converting device, and a digital-to-analog converting device. A deviation of the amplitude value having input into the feedback control part from a set value (here, an amplitude value which is desired to be set constant) is calculated, and a feedback signal for reducing the deviation is output.

The feedback signal is output to the stage device 56. The stage device 56 moves up and down in accordance with the magnitude of the oscillation of the probe 2. Consequently, an oscillation amplitude of the probe 2 with respect to the sample 40 is maintained constant.

A solvent fed from the liquid feeding device 51 is charged while passing through the electrode part 52, and is subjected to removal of a foreign substance in the filter part 53. Then, the solvent reaches the probe 2 which is oscillating. When a tip end of the probe 2 gets close to a surface of the sample 40, a liquid bridge 41 of the solvent is formed between the tip end of the probe 2 and the surface of the sample 40. Components of the sample 40 are extracted into the solvent involved with formation of the liquid bridge 41. Thereafter, while the probe 2 is moving away from the sample 40 and is moving closer to the ion take-in part 55 which functions as an ion extracting electrode, the solvent forms a Taylor cone 42 by an electric field between the solvent and the ion take-in part 55, so that charged micro droplets 43 are generated from the Taylor cone 42.

The ion take-in part 55 takes in the charged micro droplets 43. In a process of drying the micro droplets, the components of the sample 40 extracted into the solvent are changed into gas-phase ions. The gas-phase ions are introduced into the mass spectrometer 70, which is connected to the ion take-in part 55 at a location downstream of the ion take-in part 55. The mass spectrometer 70 measures a mass spectrum indicative of a relation between m/z of the ions (a value obtained by dividing an ion mass by 1/12 mass of a single carbon atom and an ion charge number) and intensity information thereof.

According to the above configuration including the oscillation measurement part 57 and the feedback control part, a distance between the tip end of the probe 2 and the surface of the sample 40 is maintained appropriately, and the liquid bridge 41 is formed in a stable manner.

The solvent reaching the probe 2 contains not only (i) originally-mixed micro particles but also foreign substance such as a micro substance generated while the solvent is passing through the tube 54. When the foreign substance reaches the tip end of the probe 2, the tip end portion is clogged therewith, resulting in poor feeding of the solvent. In order to deal with this, the filter part 53 is provided for the purpose of removing such a foreign substance. However, a foreign substance not only occurs in the tube 54 but also may possibly occur while the solvent is passing through the electrode part 52, which is made of metal.

In light of this, the above configuration has the filter part 53 disposed between the electrode part 52 and the probe 2. This makes it possible to also remove a foreign substance mixed in the solvent while the solvent is passing through the electrode part 52.

More preferably, as shown in the example in FIG. 6, the filter part 53 and the probe 2 are connected to each other not via the tube 54. In a configuration in which the filter part 53 and the probe 2 are connected to each other via the tube 54, a foreign substance generated in the tube 54 is taken into the probe 2. In contrast, the above-described configuration can removes all foreign substances generated in the tube 54.

Alternatively, the filter part 53 may be incorporated as a part of the flow passage of the probe 2 so that the filter part 53 and the probe 2 are integrated into one. Specifically, the flow passage of the probe 2 is filled with micro-scale particles. The micro-scale particles thus filled function as the filter part 53.

Note that Non-Patent Literature 2 provides details of a technique regarding the micro-scale particles which are filled in the flow passage of the probe 2 and which function as the filter part 53.

### <Data of Oscillation Stability of Probe>

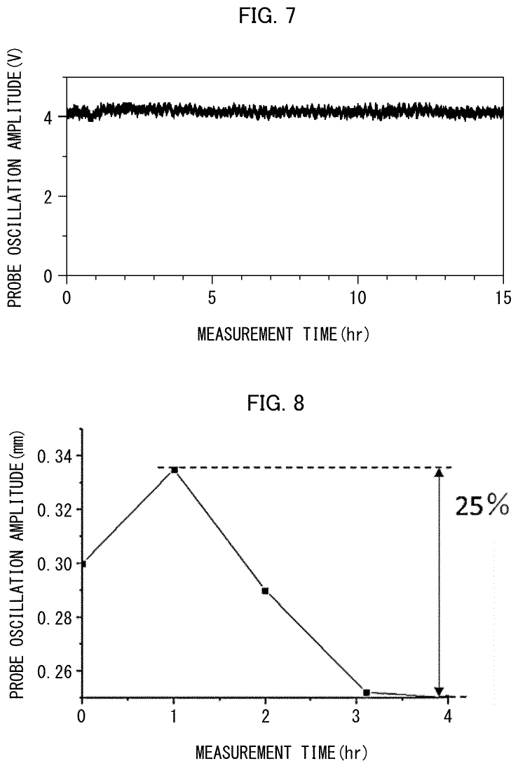

FIG. 7 is a view illustrating a result of measurement of a oscillation amplitude of the probe 2 of the oscillation device 1 in accordance with an example of the present embodiment, the measurement having been carried out with use of the oscillation measurement part 57. A probe 2 made of fused silica was used, and the probe 2 was fixed in a manner as illustrated in FIG. 2. Then, a temporal measurement of oscillation amplitude was carried out. An oscillation frequency of the probe 2 was 1017.0 Hz, and a signal input into a piezoelectric actuator for excitation, which constituted the oscillation generating part 5, was 60 Vp-p.

As shown in FIG. 7, as a result of 15-hour measurement, an average of the oscillation amplitude of the probe 2 was 4.12 V, and a variance thereof was 0.004 V. By using the fixing method of the present embodiment to fix the probe 2, it is possible to stabilize oscillation of the probe 2 for a long period.

FIG. 8 is a view illustrating a result of measurement of an oscillation amplitude of a probe of an oscillation device for comparison, the measurement having been carried out by a video camera. The oscillation device for comparison does not include the resin part 11 or the friction part 12, each of which is provided in the aspect illustrated in FIG. 2. In the oscillation device for comparison, a probe 2 is fixed by two magnet parts 7 in an up-down direction. A resonance frequency of the probe 2 was 360.9 Hz. As shown in FIG. 8, in a case of the oscillation device for comparison, the oscillation amplitude of the probe reduced by 25% in four-hour measurement. The reason why this result was given is considered as follows. That is, with the configuration in which the probe 2 was only sandwiched between the magnet parts 7, the probe 2 slipped with respect to the magnet parts 7, and consequently the contact state between the magnet parts 7 and the probe 2 changed, which caused a change in the resonance frequency.

### <Data of Mass Spectrometry Imaging>

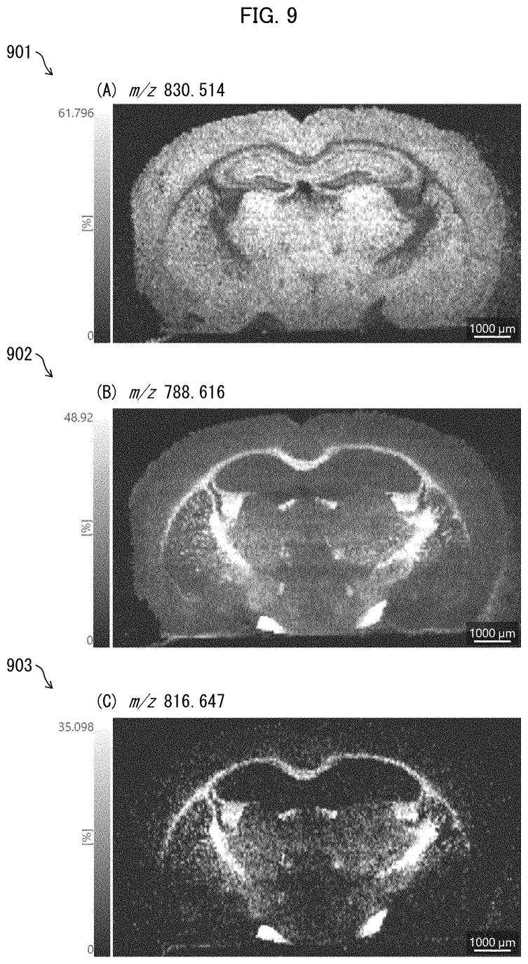

FIG. 9 is a view illustrating results of visualization of component distributions in slices of mouse brain tissues, the visualization having been carried out by the mass spectrometer 70. An experiment herein was conducted with a device configuration including the oscillation measurement part 57, the feedback control part (not illustrated), the electrode part 52, the probe 2, and the filter part 53 connected between the electrode part 52 and the probe 2. Used as the mass spectrometer 70 was LCMS-9030 (available from Shimazu Corporation).

Mouse brain tissues were cut into a slice of 8 μm with use of Cryo-microtome, and was immobilized on a slide glass, so as to prepare a sample. While letting a 1:1 mixture solvent of dimethylformamide and methanol to flow from the probe 2, the probe 2 scanned over the mouse brain tissue slice, so that tissue-derived components were extracted and ionized. The ions thus generated were subjected to measurement with the mass spectrometer 70. An oscillation frequency of the probe 2 was 800 Hz, a flow rate of the solvent was 20×10⁻³ mm³/min, and a voltage applied to the solvent was 5.5 kV.

The drawings illustrated with reference signs 901 to 903 in FIG. 9 each indicate a result of subjecting the mass spectrum data obtained in the measurement to conversion to map signal intensities of the generated ions with respect to sample positions. The drawings illustrated with reference signs 901 to 903 respectively indicate signal intensity distributions for m/z 830.514, 788.616, and 816.647. Distributions of a plurality of lipid components derived from the mouse brain tissue structure could be visualized by one measurement. The time taken for the measurement was approximately one hour and a half. Thus, stabilization of measurement was achieved by stabilizing oscillation of the probe.

### Third Embodiment

The following description will discuss another embodiment of the present invention. Note that, for convenience, members having identical functions to those of the foregoing embodiments are given identical reference signs, and their descriptions will be omitted.

In the oscillation measurement part 57 illustrated in FIG. 6, the light emitting part 58 and the light receiving part 59 are arranged so as to face each other. Each of the light emitting part 58 and the light receiving part 59 is relatively large with respect to the oscillation device 1 and is a spatially bulky part. In order to spatially arrange the light emitting part 58 and the light receiving part 59, each of which is bulky, the stage device 56 on which a sample is to be placed is disposed between the light emitting part 58 and the light receiving part 59 in such a manner that the stage device 56 does not come into physical contact with the light emitting part 58 or the light receiving part 59. Thus, the stage device 56 has a size of approximately 3 cm×4 cm, and accordingly the number of samples which can be set on the stage device 56 is limited.

In order to increase the number of samples which can be set on the stage device 56 at once, a configuration applicable to a large stage device is necessary. Further, in order to carry out measurement of a sample present in a micro area of micrometer order, a method for carrying out positional adjustment of the tip end of the probe 2 and the sample while carrying out observation with a high spatial resolution is necessary. Thus, it has been strongly desired to develop a configuration which can be combined with an optical microscope.

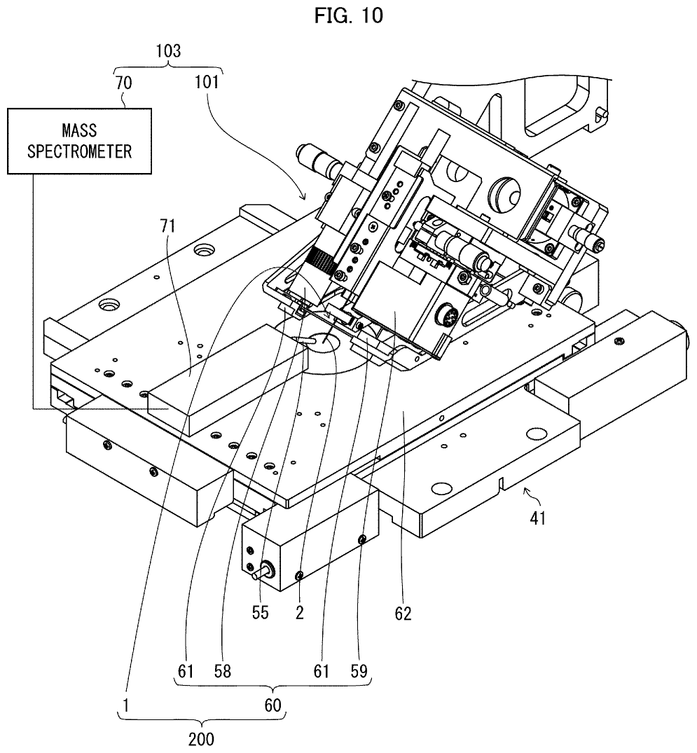

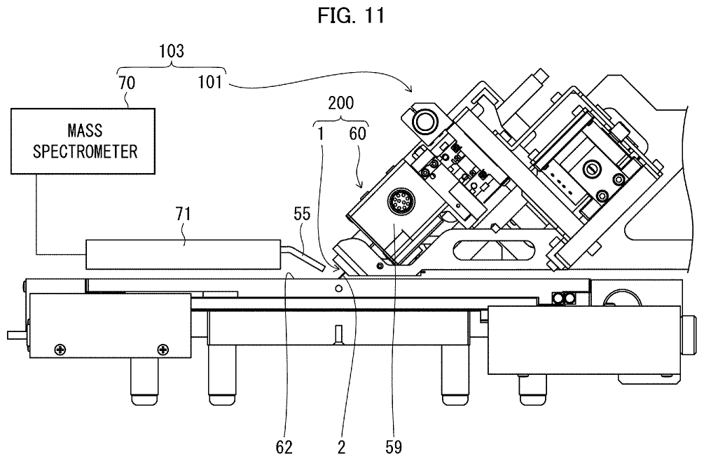

FIG. 10 is a view illustrating a configuration of an extraction-ionization system 101 and a mass spectrometry system 103 including an oscillation system 200 in accordance with an embodiment of the present invention. FIG. 11 is a view of the mass spectrometry system 101 and the extraction-ionization system 103 shown in FIG. 10, viewed in a direction of the arrow Y in FIG. 10. The extraction-ionization system 101 is a configuration which is suitably used in combination with an optical microscope or the like provided with a large stage device 62.

As shown in FIGS. 10 and 11, the extraction-ionization system 101 includes an oscillation measurement part 60 in place of the oscillation measurement part 57. The oscillation measurement part 60 and the oscillation device 1 constitute the oscillation system 200.

The oscillation measurement part 60 includes a light emitting part 58, a light receiving part 59 receiving light which exits from the light emitting part and with which information regarding oscillation has been read, and a plurality of mirrors 61. The light emitting part 58 and the light receiving part 59 are disposed so that portions of the light emitting part 58 and the light receiving part 59 which portions are closer to a tip end of a probe 2 are positioned rearward of the tip end of the probe 2 (i.e., closer to a fixed end of the probe 2). The light exiting from the light emitting part 58 is emitted to the probe 2 via at least one mirror 61, and the light having emitted to the probe 2 is reflected by at least one mirror 61 so as to enter the light receiving part 59.

In the example shown in FIGS. 10 and 11, the light emitting part 58 and the light receiving part 59 are arranged such that an optical axis of a laser beam from the light emitting part 58 and a normal line to a light receiving surface of the light receiving part 59 are in parallel with the probe 2. However, it is not essential that the light emitting part 58 and the light receiving part 59 be arranged so that the optical axis and the normal line are in parallel with the probe 2. It is only necessary that the light emitting part 58 and the light receiving part 59 be arranged such that the portions of the light emitting part 58 and the light receiving part 59 which portions are closer to the tip end of the probe 2 are positioned rearward of the tip end of the probe 2. The location rearward of the tip end of the probe 2 means a location which is closer to the oscillation device 1 than to the tip end of the probe 2.

As shown in FIG. 11, in such a configuration, the extraction-ionization system 101 including the oscillation system 200 is configured such that the light emitting part 58 and the light receiving part 59, each of which is a relatively large element, are positioned rearward of the tip end of the probe 2. Thus, it is possible to avoid interference between (i) the light emitting part 58 and the light receiving part 59 and (ii) the stage device 62. Therefore, the extraction-ionization system 101 and the mass spectrometry system 103 including the extraction-ionization system 101 can suitably be combined with an optical microscope or the like provided with a large stage device 62.

This makes it possible to set a lot of samples at the stage device 62 at once and carry out measurement, which enhances convenience. Further, this configuration makes it possible to carry out adjustment of a sample present in the micro area and the tip end of the probe 2 while carrying out optical microscopic observation thereof, thereby enhancing the efficiency of the measurement.

Illustrated here is a configuration in which the oscillation system 200 is incorporated into the extraction-ionization system 101 which uses a solvent. Therefore, the configuration employs the probe 2 including, in its inside, the flow passage through which a liquid flows. Alternatively, a probe 2 which is solid inside may be employed.

The probe 2 which is solid inside is applicable to, for example, a sample which can contain water and form a liquid bridge 41 even without a solvent fed onto a surface of the sample.

Note that the oscillation system 200 may not include the mirrors 61. Light exiting from the light emitting part 58 may be emitted to the probe 2 not via a mirror, and the light having emitted to the probe 2 may enter the light receiving part 59 not via a mirror.

### (Filter Part)

The following will explain a result of an experiment carried out with a probe having a flow passage filled with micro particles of micro scale as a filter part. A fused silica probe having a tip aperture diameter of some micrometers (hereinafter, such a fused silica probe will be referred to as a “probe”) was used. The probe was produced by using laser puller P-2000 (available from Sutter Instrument Company).

Used as the particles were ReproSil-Pur120, C18-AQ (particle A) and ReproSil-Pur1000, NH2 (particle B) (available from Dr. Maisch HPLC GmbH). Both had an average particle diameter of 3 μm. The average particle diameter is a value disclosed by the manufacturer. Further, D40/D90, which is indicative of a distribution width of particle diameter, was not more than 1.3. The particles were dispersed in a 1:1 mixture solvent of methanol and N,N-dimethylformamide. The dispersion liquid was subjected to centrifugation, a supernatant was removed therefrom, and the same mixture solvent was added thereto and the particles were dispersed again. This step was carried out ten times so as to wash the particles. After a removal operation of a final supernatant, 300 μl of the mixture solvent was added.

A cut portion (base end), opposite to an acuminated portion, of the silica probe was immersed in the dispersion liquid of the particles and was maintained therein for 45 seconds, so that the dispersion liquid was introduced into the probe. The side (base end) of the probe in which the dispersion liquid had been introduced was connected to a syringe containing methanol. Then, methanol was fed from the syringe, so that the particles inside the probe was filled in the tip end portion. In feeding of methanol, optical microscopic observation was carried out on the tip end of the probe and its proximity. Then, it was confirmed that the particles were filled in the tip end portion and that methanol flowed out of the tip end of the probe. Filling of the particles and flowing of methanol were confirmed with use of the probe having a tip aperture diameter of 1 μm to 4 μm. The probe having a length of 50 mm to 1000 mm could be used.

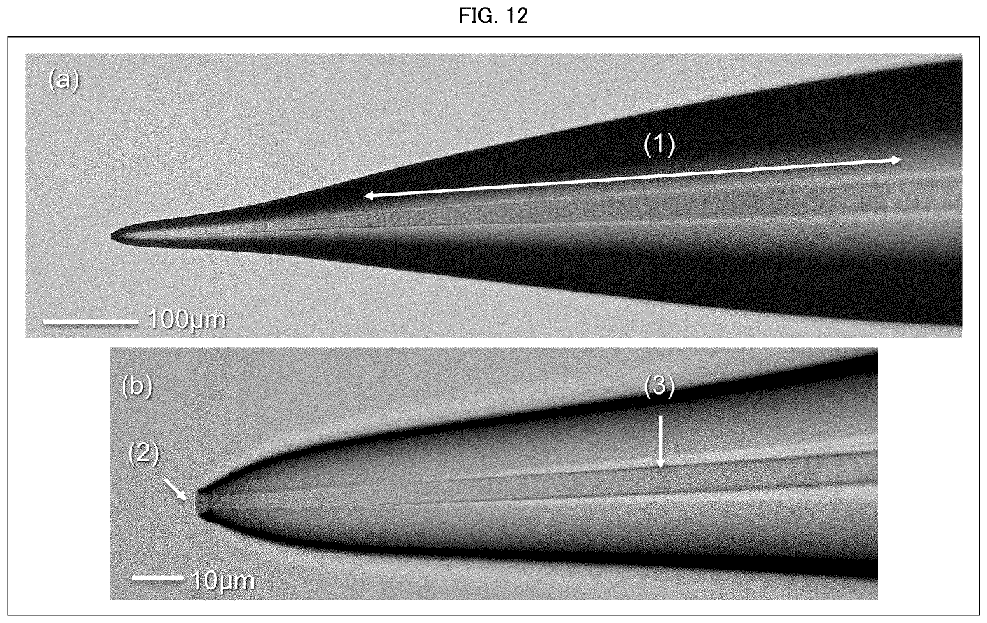

As an example of the probe filled with the particles, optical microscopic images are shown in FIG. 12. (a) of FIG. 12 is a microscopic image obtained a result of observation carried out with a 4× objective lens. It was confirmed that the tip end area of the probe was filled with beads (micro particles) (the area (1) in (a) of FIG. 12). It was confirmed that, in this area, the flow passage had a diameter larger than that of the particle and the particles were tightly filled with the particles being in contact with each other. (b) of FIG. 12 is an enlarged view of the tip end portion of the probe. (b) of FIG. 12 is a microscopic image obtained as a result of observation carried out with a 60× objective lens. The probe had a tip aperture diameter of 4 μm ((2) in (b) of FIG. 12). It was confirmed that, in the tip end and its proximity (the area (3) in (b) of FIG. 12), the flow passage had a diameter equal to the diameter of the bead and isolated particles (particles each of which was not in contact with other particles but was in contact with the flow passage) were filled in the flow passage.

While letting the 1:1 mixture solvent of methanol and N,N-dimethylformamide to flow into the probe thus prepared, a high voltage was applied to the solvent. Then, changes over time in the particles filled in the probe were observed. The voltage was applied via the electrode part 52.

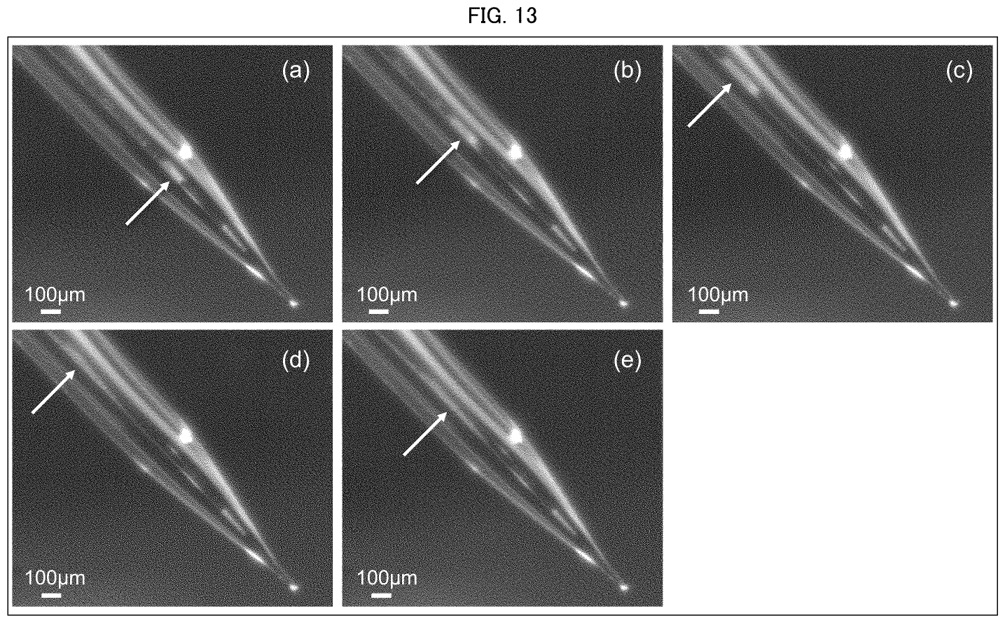

FIG. 13 shows results of observation of cases where a probe filled with particles A was used and −4 kV voltage was applied to a solvent. (a) of FIG. 13 is an image obtained when 13 seconds had elapsed after the voltage application, (b) of FIG. 13 is an image obtained when 26 seconds had elapsed after the voltage application, and (c) of FIG. 13 is an image obtained when 63 seconds had elapsed after the voltage application. It was confirmed that, during the voltage application, the particles inside the probe (each of the arrows in (a), (b), and (c) of FIG. 13) moved upward (toward the base end) as time elapsed. Thereafter, when the voltage was set at 0 V, the particles inside the probe moved downward gradually (each of the arrows in (d) and (e) of FIG. 13).

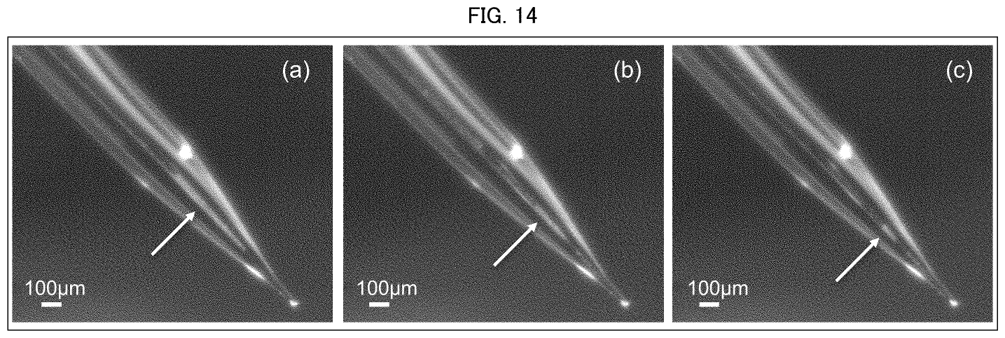

Further, FIG. 14 shows results of observation of cases where a probe filled with particles A was used and +4 kV voltage was applied to a solvent. (a) of FIG. 14 is an image obtained before the voltage application, (b) of FIG. 14 is an imaged obtained when 45 seconds had elapsed after the voltage application, and (c) of FIG. 14 is an imaged obtained when 100 seconds had elapsed after the voltage application. It was confirmed that, during the voltage application, the particles inside the probe moved upward as time elapsed and an amount of the particles filled in the tip end portion of the probe (each of the arrows in (a), (b), and (c) of FIG. 14) reduced.

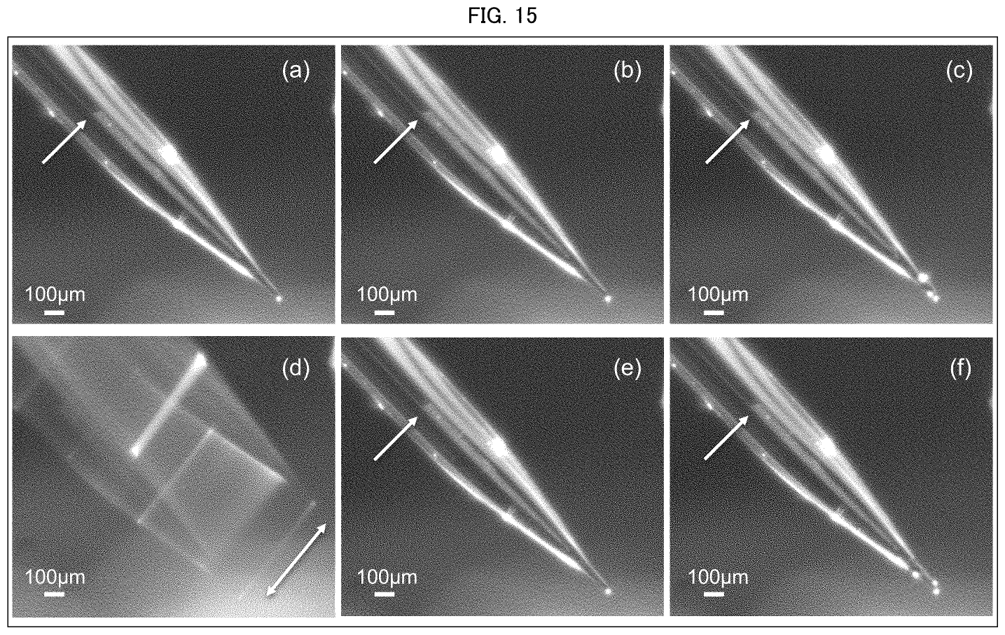

Next, FIG. 15 shows results of observation of cases where a probe filled with particles B was used and −4 kV voltage was applied to a solvent. (a) of FIG. 15 is an image obtained immediately after the voltage application, and (b) of FIG. 15 is an image obtained when 75 seconds had elapsed after the voltage application. It was confirmed that, even the voltage was applied, the particles inside the probe (each of the arrows in (a) and (b) of FIG. 15) did not move over time but stayed at the same positions. Each of the arrows in the drawings indicates a boundary between the particles and the solvent. It was also confirmed that, even after the voltage was changed to 0 V, the particles inside the probe did not move but stayed at the same positions (the arrow in (c) of FIG. 15). Further, it was observed that, even after the voltage was set at 0 V, the solvent flowed out of the tip end of the probe.

Subsequently, while −4 kV voltage was being applied to the solvent, the probe was caused to oscillate in an up-down direction at a resonance frequency of 523 Hz for 110 seconds. The arrow in (d) of FIG. 15 indicates the oscillation direction. It was confirmed that, when the oscillation stopped thereafter, the particles inside the probe did not move but stayed at the same positions (the arrow in (e) of FIG. 15). Further, it was also confirmed that, even after the voltage was set at 0 V, the particles inside the probe did not move over time but stayed at the same positions (the arrow in (f) of FIG. 15).

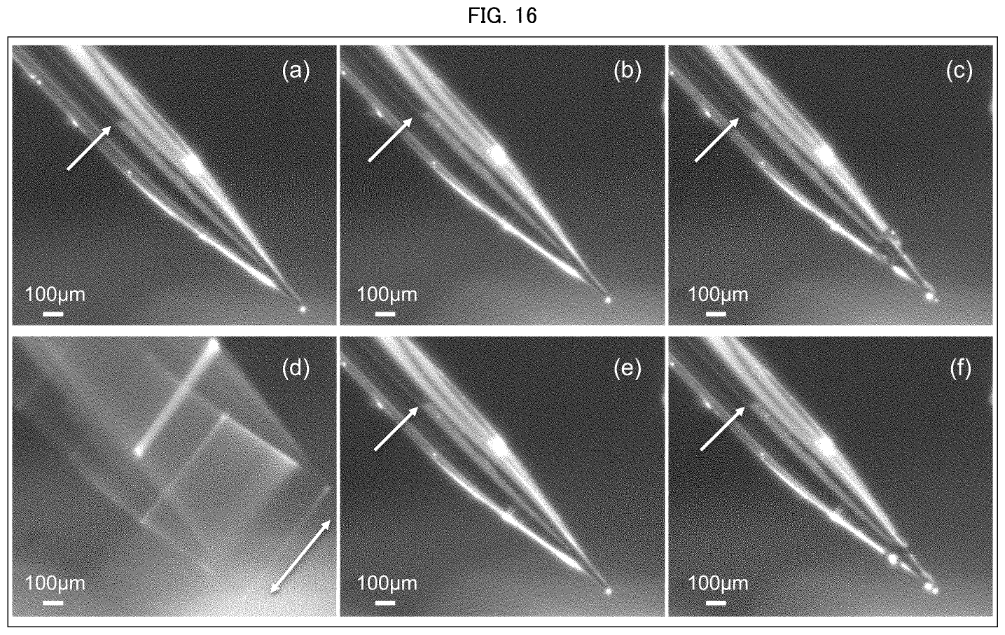

Further, FIG. 16 shows results of observation of cases where a probe filled with particles B was used and +4 kV voltage was applied to a solvent. (a) of FIG. 16 is an image obtained immediately after the voltage application, and (b) of FIG. 16 is an image obtained when 150 seconds had elapsed after the voltage application. It was confirmed that, similarly to the case where −4 kV voltage was applied, the particles inside the probe (each of the arrows in (a) and (b) of FIG. 16) did not move over time but stayed at the same positions. Further, it was also confirmed that, even after the voltage was set at 0 V, the particles inside the probe did not move over time but stayed at the same positions (the arrow in (c) of FIG. 16).

Subsequently, while +4 kV voltage was being applied to the solvent, the probe was caused to oscillate in an up-down direction at a resonance frequency of 523 Hz for 110 seconds. The arrow in (d) of FIG. 16 indicates the oscillation direction. It was confirmed that, when the oscillation was stopped thereafter, the particles inside the probe stayed at the same positions (the arrow in (e) of FIG. 16). Further, it was confirmed that, even after the voltage was set at 0 V, the particles inside the probe did not move over time but stayed at the same positions (the arrow in (f) of FIG. 16).

From these results, it was found that different particles take different effects on movement of the particles, the effects being given by application of a voltage to the solvent. The reason why the particles A moved but the particles B did not move is considered that (i) an interaction between the particles A and the probe and (ii) an interaction between the particles B and the probe differ from each other.

The particles A contained a silica gel base material having a surface to which octadecyl groups were chemically bonded, but the surface of the silica gel partially had silanol groups. Meanwhile, the probe was made of fused silica, and the surface of the flow passage partially had silanol groups. It is considered that, when the surface is negatively charged as a result of polarization of the silanol groups, repulsive force is generated between the particles A and the surface of the flow passage, and the particles A is not fixed to the flow passage but become likely to move.

It is considered that the movement of the particles A in response to the voltage application to the solvent occurred according to the following mechanisms: (i) The particles having negatively charged surfaces move toward the electrode part 52 to which a positive voltage is applied; (ii) In the flow passage, electroosmotic flow occurs toward the electrode part 52 to which a negative voltage is applied, and the particles A move in the electroosmotic flow.

Meanwhile, the particles B contained a silica gel base material having a surface to which amino groups were chemically bonded. It is considered that the amino groups formed hydrogen bonds with the silanol groups in the flow passage so that they were fixed in a stable manner and this suppressed movement of the particles B even when the voltage was applied.

In order to stably feed the solvent to the flow passage at a certain flow rate, it is important that the particles do not move even when a voltage is applied to the solvent or even when the probe oscillates. It was confirmed that, with the probe filled with the particles A having moved in the flow passage, it became impossible to carry out the feeding during the experiment. The reason why this happened is considered that, while the particles were moving in response to application of the voltage, micro objects present in the solvent reached the tip end of the probe and the flow passage was clogged therewith. It was confirmed that, with the probe filled with the particles B, the particles served as a filter and prevented micro objects in the solvent from moving to the tip end of the probe and this made it possible to feed the solvent in a stable manner.

In the method explained herein, the flow passage is filled with the particles modified with molecules having an amino group. However, this is not limitative. Alternatively, part of the structures of the molecules bonded to the surface of the particle may have an amino group. Further alternatively, in order to form chemical bonds between the surface of the flow passage and the surfaces of the particles, at least either of the surface of the flow passage and the surfaces of the particles may be modified with an organic molecule. Still further alternatively, the particles having a silanol group on their surfaces may be filled in a probe made of fused silica, and then a thermal treatment may be carried out thereon to cause dehydration polymerization between the silanol group, thereby forming covalent bonds between the flow passage and the particles.

Further, in order to carry out the dispersion and cleaning of the particles, a 1:1 mixture solvent of methanol and N,N-dimethylformamide (volume ratio) was used. It was confirmed that, with this mixture solvent, extraction and ionization of lipid components in tissues could be carried out without causing breakage of the shapes of the biological tissues. By using the same solvent for mass spectrometry of the biological tissues and for filling of the micro particles, it is possible to simplify preparation of the solvent. The filling of the particles into the probe may be carried out with use of another solvent, provided that it is a solvent usable for particle dispersion and cleaning. For example, it is also possible to use only methanol, only N,N-dimethylformamide, a pure solvent such as acetonitrile, ultrapure water, or ethanol, or a mixture solvent of any of them.

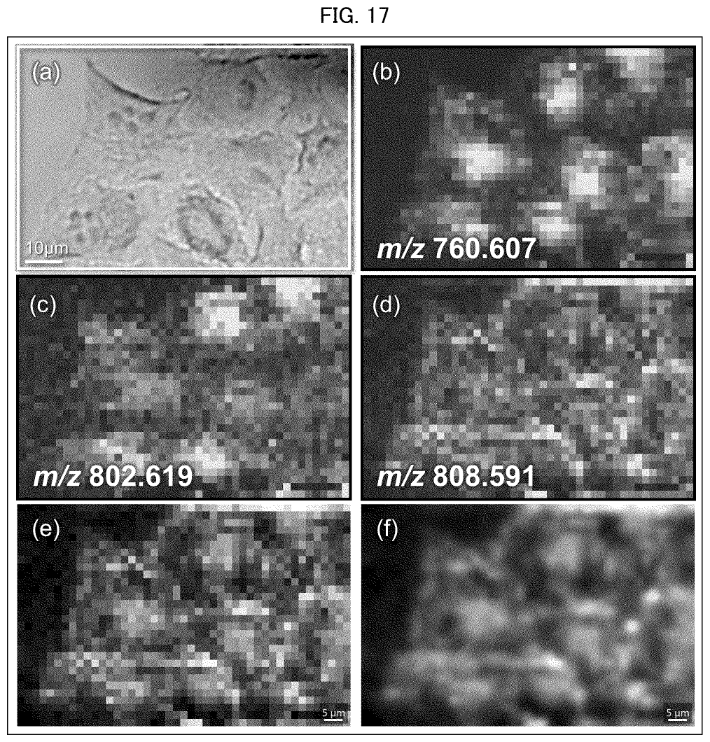

FIG. 17 shows results of measurement of component distributions in cells, the measurement having been carried out with use of a probe filled with particles. An experiment herein was conducted with a device configuration including the oscillation measurement part 57, the feedback control part (not illustrated), the electrode part 52, the probe 2, and the filter part 53 connected between the electrode part 52 and the probe 2. Used as the mass spectrometer 70 was Xevo G2-XS QTOF (available from Waters).

Cultured HeLa cells were set on a cover glass as a sample. Dimethylformamide and methanol were mixed at a volume ratio of 1:1, and a solvent containing 0.1% formic acid added thereto was applied. The probe 2 scanned over the cells, so as to extract and ionize cell-derived components. The generated ions were measured with the mass spectrometer 70. A tip aperture diameter of the probe 2 was 1.5 μm, an oscillation frequency of the probe 2 was 291 Hz, a flow rate of the solvent was 5×10⁻⁴ mm³/min, and a voltage applied to the solvent was 2.85 kV.

(a) of FIG. 17 shows a bright field image of the cells obtained by optical microscopic observation. It was confirmed that isolated cells were present on the substrate. (b), (c), and (d) of FIG. 17 each indicate a result of subjecting the mass spectrum data obtained in the measurement to conversion to map signal intensities of the generated ions with respect to sample positions. The drawings in (b), (c), and (d) of FIG. 17 respectively indicate signal intensity distributions for m/z 760.607, 802.619, and 808.591. In an area where the cells were present, distributions of a plurality of lipid components could be visualized at 2 μm-pixel internals. (e) of FIG. 17 shows an image in which the images of (b), (c), and (d) of FIG. 17 were overlaid. The images of (b), (c), and (d), which were respectively red, green, and blue images, were all overlaid. This yielded a color image in which differences in localization between three kinds of lipids in the cells were visualized. Furthermore, it was confirmed that subjecting the image of (e) of FIG. 17 to image processing with a Gaussian filter and a linear interpolating filter could increase a spatial resolution of the intensity distributions in the cells in a pseudo manner ((f) of FIG. 17).

In the configuration described herein, the mass spectrometry system 103 combined with the optical microscope provided with the large stage device 62 was used to observe morphologies of the cells, and extraction and ionization were carried out in the same view field. For the observation of the morphologies of samples, not only the bright field image but also a phase difference image, a fluorescent image, a Raman spectroscopic image, and/or an infrared spectroscopic image can be obtained.

In order to analyze component distributions in cells, it is important to enhance a spatial resolution. When a probe having a small tip aperture diameter is used, a tip end of the probe becomes likely to be clogged with micro particles in a solvent, which makes it difficult to carry out stable measurement. However, filling particles in a probe makes it possible to prevent or suppress clogging of a flow passage for a solvent, thereby making it possible to feed the solvent in a stable manner.

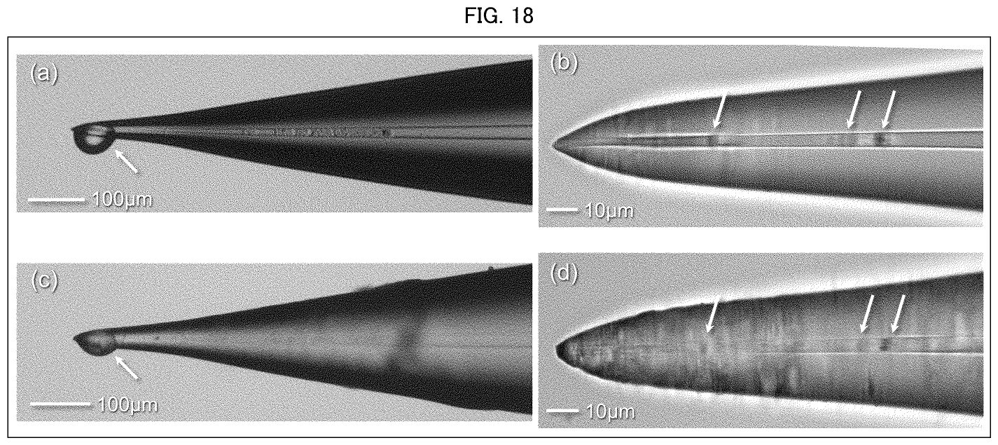

FIG. 18 shows results of optical microscopic observation of a tip-end area of a probe having been used for measurement. (a) and (b) of FIG. 18 respectively show optical microscopic images of tip-end areas of probes before measurement. It was confirmed that, in the probe before the measurement, a solvent having flowed inside the probe exited from the tip end of the probe (the arrow portion in (a) of FIG. 18). Further, it was observed that, from an enlarged view of the tip end portion, isolated micro particles were filled in a plurality of portions in the probe (the arrow portions in (b) of FIG. 18).

(c) and (d) of FIG. 18 respectively show optical microscopic images of tip-end areas of probes after measurement. It was confirmed that, in the probe after the measurement, a solvent having flowed inside a flow passage exited from the tip end of the probe (the arrow portion in (c) of FIG. 18), similarly to the probe before the measurement. Further, it was observed that, from an enlarged view of the tip end portion, isolated micro particles did not move but stayed at the same positions in the probe (the arrow portions in (d) of FIG. 18).

Aspects of the present invention can also be expressed as follows:

An oscillation device in accordance with a first aspect of the present invention is an oscillation device that oscillates a probe which is cantilevered, the oscillation device including: a probe; two fixing members between which the probe is sandwiched and supported; and an oscillation generating part which gives oscillation to at least one of the two fixing members, at least one of the two fixing members having a recessed part in which the probe is disposed with the probe being sandwiched between the two fixing members, the recessed part being formed in a portion of the at least one of the two fixing members which portion corresponds to the probe in position.

According to the above configuration, the oscillating probe is fixed to the recessed part. This can stabilize oscillation of the probe for a long period.

An oscillation device in accordance with a second aspect of the present invention may be configured such that, in the first aspect, (i) both the two fixing members have permanent magnets or (ii) one of the two fixing members has a permanent magnet and the other of the two fixing members has a magnetic substance.

An oscillation device in accordance with a third aspect of the present invention may be configured such that, in the first or second aspect, the recessed part is formed in the at least one of the two fixing members in advance.

An oscillation device in accordance with a fourth aspect of the present invention may be configured such that, in the third aspect, the recessed part is formed in one of the two fixing members in advance; the recessed part has a shape having a rectangular cross section; and the probe disposed in the recessed part is in contact with one wall of the recessed part.

An oscillation device in accordance with a fifth aspect of the present invention may be configured such that, in any one of the first to fourth aspects, the at least one of the two fixing members has a resin part in a surface of the at least one of the two fixing members which surface faces the probe, and the recessed part is formed in the resin part.

An oscillation device in accordance with a sixth aspect of the present invention may be configured such that, in the fifth aspect, the resin part is detachable from the at least one of the two fixing members having the resin part.

An oscillation device in accordance with a seventh aspect of the present invention may be configured such that, in any one of the first to sixth aspects, the at least one of the two fixing members has the recessed part; and the other of the two fixing members which does not have the recessed part has a friction part in a surface of the other of the two fixing members which surface faces the probe, the friction part being configured to be in contact with the probe to restrict movement of the probe by friction force.

An oscillation device in accordance with an eighth aspect of the present invention may be configured such that, in any one of the first to seventh aspects, the probe has a flow passage which is provided inside the probe and through which a liquid passes.

An oscillation system in accordance with a ninth aspect of the present invention includes: an oscillation device of any one of the first to eighth aspects; and an oscillation measurement part which outputs a signal for feedback control of oscillation of the probe, the oscillation measurement part including a light emitting part and a light receiving part receiving light which exits from the light emitting part and with which information regarding oscillation of the probe has been read, the light exiting from the light emitting part being emitted to the probe, and the light emitted to the probe entering the light receiving part.

An oscillation system in accordance with a tenth aspect of the present invention includes: an oscillation device of any one of the first to eighth aspects; and an oscillation measurement part which outputs a signal for feedback control of oscillation of the probe, the oscillation measurement part including a light emitting part, a light receiving part receiving light which exits from the light emitting part and with which information regarding oscillation of the probe has been read, and a plurality of mirrors, portions of the light emitting part and the light receiving part which portions are closer to a tip end of the probe being positioned rearward of the tip end of the probe, the light exiting from the light emitting part being emitted to the probe via at least one of the plurality of mirrors, the light emitted to the probe being reflected by at least one of the plurality of mirrors so as to enter the light receiving part.

An extraction-ionization system in accordance with an eleventh aspect of the present invention includes: an oscillation device of the eighth aspect or an oscillation system of the ninth or tenth aspect; a liquid feeding device which feeds a liquid to the probe; an electrode part which charges the liquid; and a filter part which removes a foreign substance contained in the liquid, the filter part being disposed between the electrode part and the probe.

The extraction-ionization system oscillates the probe so that the probe comes in contact with a sample intermittently. With this, the extraction-ionization system extracts components of the sample into the solvent fed from the probe, holds an extraction liquid with the probe, and then carries out electrospray ionization.

An extraction-ionization system in accordance with a twelfth aspect of the present invention may be configured such that, in the eleventh aspect, the filter part and the probe are connected to each other not via a tube.

An extraction-ionization system in accordance with a thirteenth aspect of the present invention may be configured such that, in the eleventh aspect, a part of the flow passage in the probe has the filter part incorporated thereinto.

An extraction-ionization system in accordance with a fourteenth aspect of the present invention may be configured such that, in the eleventh or thirteenth aspect, a part of the flow passage in the probe is filled with micro particles serving as the filter part.

An extraction-ionization system in accordance with a fifteenth aspect of the present invention may be configured such that, in the eleventh or thirteenth aspect, a part of the flow passage in the probe is filled with isolated micro particles.

An extraction-ionization system in accordance with a sixteenth aspect of the present invention may be configured such that, in the fourteenth or fifteenth aspect, the micro particles have a chemical bond with a surface of the flow passage.

An extraction-ionization system in accordance with a seventeenth aspect of the present invention may be configured such that, in any one of the fourteenth to sixteenth aspects, the micro particles have, on surfaces thereof, an amino group.

An extraction-ionization system in accordance with an eighteenth aspect of the present invention may be configured such that, in any one of the fourteenth to seventeenth aspects, a base material of the micro particles is silica gel.

A mass spectrometry system in accordance with a nineteenth aspect of the present invention includes: an extraction-ionization system of any one of the eleventh to eighteenth aspects; and a mass spectrometer.

An oscillation method in accordance with a twentieth aspect of the present invention is an oscillation method that oscillates a probe which is cantilevered, the oscillation method including the steps of: sandwiching and supporting the probe between two fixing members so that the probe is disposed in a recessed part of at least one of the two fixing members with the probe being sandwiched between the two fixing members, the recessed part being formed in a portion of the at least one of the two fixing members which portion corresponds to the probe in position; and giving oscillation to one of the two fixing members.

The present invention is not limited to the embodiments, but can be altered by a skilled person in the art within the scope of the claims. The present invention also encompasses, in its technical scope, any embodiment derived by combining technical means disclosed in differing embodiments.

### REFERENCE SIGNS LIST

1: oscillation device
2: probe
3, 4: fixing member
5: oscillation generating part
7: magnet part
10: recessed part
11: resin part
12: friction part
15: hinge
16: protruding part
17: plate member
18: plate spring
19: fastening member
20: projection
40: sample
41: liquid bridge
42: Taylor cone
43: micro droplet
51: liquid feeding device
52: electrode part
53: filter part
54: tube
55: ion take-in part
56, 62: stage device
57, 60: oscillation measurement part
58: light emitting part
59: light receiving part
61: mirror
70: mass spectrometer
100, 101: extraction-ionization system
102, 103: mass spectrometry system
200: oscillation system

1-20. (canceled)

21. An oscillation device that oscillates a probe which is cantilevered, the oscillation device comprising:
a probe having an axis direction;
first and second fixing members between which the probe is sandwiched and supported in a first direction which is orthogonal to the axis direction; and
an oscillation generating part which gives oscillation to at least one of the first and second fixing members,
the first fixing member having a recessed part formed entirely in a portion of the first fixing member which portion extends along the axis direction with the probe being sandwiched between the first and second fixing members,
the probe being disposed over the entire recessed part,
the recessed part working with the first fixing member to restrict movement of the prove in a second direction which is orthogonal to the axis direction and the first direction.

22. The oscillation device according to claim 21, wherein:
(i) both the first and second fixing members have permanent magnets or (ii) one of the first and second fixing members has a permanent magnet and the other of the first and second fixing members has a magnetic substance.

23. The oscillation device according to claim 21, wherein:
the recessed part is formed in the first fixing member in advance.

24. The oscillation device according to claim 23, wherein:
the recessed part has a shape having a rectangular cross section; and
the probe disposed in the recessed part is in contact with one wall of the recessed part.

25. The oscillation device according to claim 21, wherein:
the second fixing member which does not have the recessed part has a friction part in a surface of the second fixing member which surface faces the probe, the friction part being configured to be in contact with the probe to restrict movement of the probe by friction force.

26. The oscillation device according to claim 21, wherein:
the probe has a flow passage which is provided inside the probe and through which a liquid passes.

27. The oscillation device according to claim 21, further comprising:
a pushing part which presses the first fixing member onto the probe.

28. An oscillation device that oscillates a probe which is cantilevered, the oscillation device comprising:
a probe;
two fixing members between which the probe is sandwiched and supported; and
an oscillation generating part which gives oscillation to at least one of the two fixing members,
at least one of the two fixing members having a recessed part in which the probe is disposed with the probe being sandwiched between the two fixing members, the recessed part being formed in a portion of the at least one of the two fixing members which portion corresponds to the probe in position,
the at least one of the two fixing members having a resin part in a surface of the at least one of the two fixing members which surface faces the probe, and the recessed part being formed in the resin part.

29. The oscillation device according to claim 28, wherein:
the resin part is detachable from the at least one of the two fixing members having the resin part.

30. An oscillation system comprising:
an oscillation device recited in claim 21; and
an oscillation measurement part which outputs a signal for feedback control of oscillation of the probe,
the oscillation measurement part including a light emitting part and a light receiving part receiving light which exits from the light emitting part and with which information regarding oscillation of the probe has been read,
the light exiting from the light emitting part being emitted to the probe, and the light emitted to the probe entering the light receiving part.

31. An oscillation system comprising:
an oscillation device recited in claim 21; and
an oscillation measurement part which outputs a signal for feedback control of oscillation of the probe,
the oscillation measurement part including
a light emitting part,
a light receiving part receiving light which exits from the light emitting part and with which information regarding oscillation of the probe has been read, and
a plurality of mirrors,
portions of the light emitting part and the light receiving part which portions are closer to a tip end of the probe being positioned rearward of the tip end of the probe,
the light exiting from the light emitting part being emitted to the probe via at least one of the plurality of mirrors, the light emitted to the probe being reflected by at least one of the plurality of mirrors so as to enter the light receiving part.

32. An extraction-ionization system comprising:
an oscillation device recited in claim 21;
a liquid feeding device which feeds a liquid to the probe; and
an electrode which charges the liquid,
the probe having a flow passage which is provided inside the probe and through which the liquid passes, and
the liquid feeding device being connected to an end of the probe.

33. An extraction-ionization system comprising:
an oscillation device recited in claim 26;
a liquid feeding device which feeds a liquid to the probe;
an electrode part which charges the liquid; and
a filter part which removes a foreign substance contained in the liquid,
the filter part being disposed between the electrode part and the probe.

34. The extraction-ionization system according to claim 33, wherein:
the filter part and the probe are connected to each other not via a tube.

35. The extraction-ionization system according to claim 33, wherein:
a part of the flow passage in the probe has the filter part incorporated thereinto.

36. The extraction-ionization system according to claim 33, wherein:
a part of the flow passage in the probe is filled with micro particles serving as the filter part.

37. An extraction-ionization system, comprising:
an oscillation device which oscillates a probe that is cantilevered;
a liquid feeding device which feeds a liquid to the probe; and
an electrode which charges the liquid,
the oscillation device including:
a probe having a flow passage which is provided inside the probe and through which the liquid passes;
two fixing members between which the probe is sandwiched and supported; and
an oscillation generating part which gives oscillation to at least one of the two fixing members,
at least one of the two fixing members having a recessed part in which the probe is disposed with the probe being sandwiched between the two fixing members, the recessed part being formed in a portion of the at least one of the two fixing members which portion corresponds to the probe in position,
the extraction-ionization system further comprising:
a filter part which removes a foreign substance contained in the liquid,
the filter part being disposed between the electrode and the probe, and
a part of the flow passage in the probe being filled with isolated micro particles.

38. The extraction-ionization system according to claim 36, wherein:
the micro particles have a chemical bond with a surface of the flow passage.

39. The extraction-ionization system according to claim 36, wherein:
the micro particles have, on surfaces thereof, an amino group.

40. The extraction-ionization system according to claim 36, wherein:
a base material of the micro particles is silica gel.

41. A mass spectrometry system comprising:
an extraction-ionization system recited in claim 32; and
a mass spectrometer.

42. An oscillation method that oscillates a probe which is cantilevered, the oscillation method comprising the steps of:
sandwiching and supporting the probe between two fixing members so that the probe is disposed in an entire recessed part of at least one of the two fixing members with the probe being sandwiched between the two fixing members, the recessed part being formed entirely in a portion of the at least one of the two fixing members which portion extends in an axis direction of the probe and corresponds to the probe in position; and
giving oscillation to one of the two fixing members.
